(19) United States
(12) Patent Application Publication
(10) Pub. No.: US 2009/0233167 A1
(43) Pub. Date: Sep. 17, 2009

(54) Capacity Increasing Current Collector and Fuel Gauge for Lithium-Containing Electrochemical Cell

(75) Inventor: Guanghong Zheng, Westlake, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: Eveready Battery Company, Inc.

(21) Appl. No.: 12/049,527

(22) Filed: Mar. 17, 2008

(51) Int. Cl. H01M 2/30; H01M 2/08; H01M 6/16; H01M 4/24

(52) U.S. Cl. 429/178; 429/185; 429/324; 429/246

(57) ABSTRACT

An electrochemical battery cell having a negative electrode, such as a negative electrode, including lithium, that is provided with a fuel gauge or end of life indicator capable of generating a voltage step preferably indicating that the cell is close to the end of its life and should be replaced, wherein the voltage step is detectable by a device associated with the cell. Additional capacity is added to the cell by utilizing a current collector comprising a consumable electrochemically active material having a lower potential than the electrochemically active material of the associated electrode, such as lithium, and a discharge voltage above a predetermined cut-off voltage.

### FIELD OF THE INVENTION

The present invention relates to an electrochemical cell having a negative electrode, such as a negative electrode including lithium, that is provided with a fuel gauge or end of life indicator capable of generating a voltage step preferably indicating that the cell is close to the end of its life and should be replaced, wherein the voltage step is detectable by a device associated with the cell. Additional capacity is added to the cell by utilizing a current collector comprising a consumable electrochemically active material having a lower potential than the electrochemically active material of the associated electrode, such as lithium, and a discharge voltage above a predetermined cut-off voltage.

### BACKGROUND OF THE INVENTION

Various cell constructions use metallic lithium and lithium alloys as negative electrode active materials. Lithium-containing cells are used in many electronic devices to generate electrical energy. Lithium-containing cells are preferred for use in high drain devices such as digital still cameras due to their relatively high energy density, for example when compared to alkaline cells.

Cells such as lithium/iron disulfide cells exhibit a relatively flat discharge curve during discharge, for example when compared to alkaline cells using a zinc/manganese dioxide electrode construction. However, the relatively flat discharge curve can cause problems as typical battery life monitors utilizing voltage measurements can be generally unreliable. Moreover, the cell voltage in some embodiments can drop sharply at the end of cell life without much warning, therefore, making use of lithium-containing cells unsuitable or undesirable for applications such as medical devices and smoke detectors.

In view of the problems identified above, it would be desirable to provide an electrochemical cell, preferably a lithium-containing cell, with an end of life indicator or fuel gauge so that the cell can be replaced prior to failure of a device due to power loss.

### SUMMARY OF THE INVENTION

An object of the present invention is to provide an electrode assembly having a dischargeable electrode having a first potential and a dischargeable current collector having a second potential lower than the first potential, with the current collector being in electrical contact with the electrode. The second potential is at or above a functional voltage of the cell, thereby increasing the useful capacity of the cell.

A further object of the present invention is to provide an electrochemical cell having a negative electrode and a current collector in electrical contact with the electrode, wherein the negative electrode and current collector each comprise electrochemically active material that is consumed upon discharge and the ratio of electrochemically active material in the negative electrode and consumable current collector combination compared to the positive electrode of the cell is less than 1.0. A preferred object is to provide an anode and a consumable anode current collector, wherein the anode and anode current collector to cathode theoretical input capacity ratio is less than 1.0 such that the anode and anode current collector are both essentially consumed.

An additional object of the present invention is to provide a cell, such as a lithium-containing electrochemical cell having a reliable cell life indicator that provides notice that the cell is near the end of its life and, therefore, should be replaced.

A further object of the present invention is to provide a primary electrochemical cell, preferably a lithium-containing electrochemical cell, with a fuel gauge without having to reduce the space available for active materials.

A further object of the present invention is to provide a primary electrochemical cell having a lithium or lithium alloy negative electrode and a secondary dischargeable electrochemically active material in a current collector of the negative electrode that serves as a fuel gauge or battery life indicator, preferably wherein the secondary active material has a lower potential than the lithium and a discharge voltage greater than or equal to a desired cut-off voltage of the cell that provides additional capacity to the cell.

Yet another object of the present invention is to provide a primary electrochemical cell having a lithium or lithium alloy negative electrode that is in contact with a dischargeable current collector such as one or more of a) an electrode lead or tab and b) an anode or negative electrode backing that is formed from an electrochemically active material, such as one or more of calcium, magnesium, and sodium that provides a second voltage-indicating step in a discharge curve after the lithium has been discharged and thereby serves as a fuel gauge for the cell.

Still a further object of the present invention is to provide an electrochemical cell having a lithium or lithium alloy negative electrode and an associated dischargeable lead which adds to the capacity of the cell, wherein the lead has a lower potential than the lithium and a functional discharge voltage that serves as a fuel gauge indicator being dischargeable after substantial discharge of the lithium, wherein the lead is in electrical contact with the negative electrode and a portion of the cell container or an end assembly of the cell.

In one aspect of the present invention, a primary electrochemical cell is disclosed, comprising a conductive container of a first polarity sealed by an end assembly having a contact of a second polarity, an electrode assembly including a positive electrode, a negative electrode, and a separator disposed between the positive electrode and negative electrode, wherein one of the electrodes is in operative electrical contact with the container and the other electrode is in operative electrical contact with the contact of the end assembly, an electrolyte, and a consumable current collector in electrical contact with the negative electrode, wherein the current collector includes a dischargeable electro-chemically active material having a lower potential than an electrochemically active material of the negative electrode, and wherein the consumable current collector has a functional voltage within the cell.

In another aspect of the present invention, an electrochemical cell is disclosed, comprising a conductive container having a closed end, an open end sealed by an end assembly, and a sidewall extending between the closed end and the open end, a positive electrode, a negative electrode consisting essentially of lithium or a lithium alloy, a separator, a nonaqueous, organic electrolyte, a current collector in electrical contact with the negative electrode, wherein the current collector includes a dischargeable electro-chemically active material having a lower potential than the lithium and lithium alloy, wherein the current collector has a functional voltage in the cell, and wherein the positive electrode, the negative electrode and the separator are wound into a jellyroll electrode assembly and the negative electrode is operatively in electrical contact with the container or the end assembly.

In still a further aspect of the present invention, an electrochemical cell is disclosed, comprising a substantially cylindrical, conductive container having a closed end, an open end sealed by an end assembly, and a sidewall extending between the closed end and the open end, a positive electrode, a negative electrode consisting essentially of lithium or a lithium alloy, a separator, a nonaqueous, organic electrolyte, a current collector in electrical contact with the negative electrode, wherein the current collector includes at least 50% by volume of one or more of calcium, magnesium and sodium, and wherein the current collector is dischargeable, and wherein the positive electrode, the negative electrode and the separator are wound into a jellyroll electrode assembly and the negative electrode is operatively in electrical contact with the container or the end assembly.

In yet a further aspect of the present invention, an electrochemical cell is disclosed, comprising a substantially cylindrical, conductive container having a closed end, an open end sealed by an end assembly, and a sidewall extending between the closed end and the open end, a positive electrode, a negative electrode consisting essentially of lithium or a lithium alloy, a separator, a nonaqueous, organic electrolyte, a consumable internal lead located in the container and in electrical contact with the negative electrode and a portion of the container or the end assembly, wherein the lead includes a dischargeable electrochemically active material having a lower potential than the lithium and the lithium alloy, wherein the lead has a functional voltage in the cell, and wherein the positive electrode, the negative electrode and the separator are wound into a jellyroll electrode assembly and the negative electrode is operatively in electrical contact with the container or the end assembly.

The present invention achieves these and other objectives which will become apparent from the description that follows.

### BRIEF DESCRIPTION OF THE DRAWINGS

The invention will be better understood and other features and advantages will become apparent by reading the detailed description of the invention, taken together with the drawings, wherein:

FIG. 1 is a longitudinal cross-sectional view of an electrochemical cell with a lead disposed between the inside of the container wall and the external surface of the negative electrode for making electrical contact between the container and electrode;

FIG. 2 is an enlarged view of a portion of the cell in FIG. 1 showing the location of the negative electrode lead contacting the container;

FIG. 3 is a graph of discharge curves of lithium/iron disulfide electrochemical cells discharged at 75 mA, wherein one of the cells had a steel current collector and the other cell had a dischargeable magnesium current collector that provided one additional voltage step;

FIG. 4 is an axial cross-section through the electrode assembly illustrated in FIG. 1; and

FIG. 5 is an axial cross-section of one embodiment of a jellyroll electrode assembly for a cell showing a portion of a positive electrode interfacially arranged adjacent a dischargeable lead of the present invention.

### DETAILED DESCRIPTION OF THE INVENTION

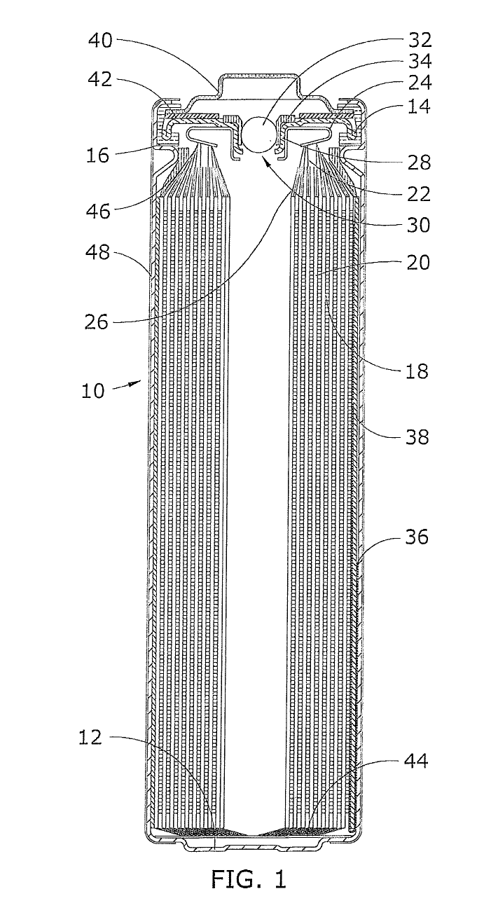

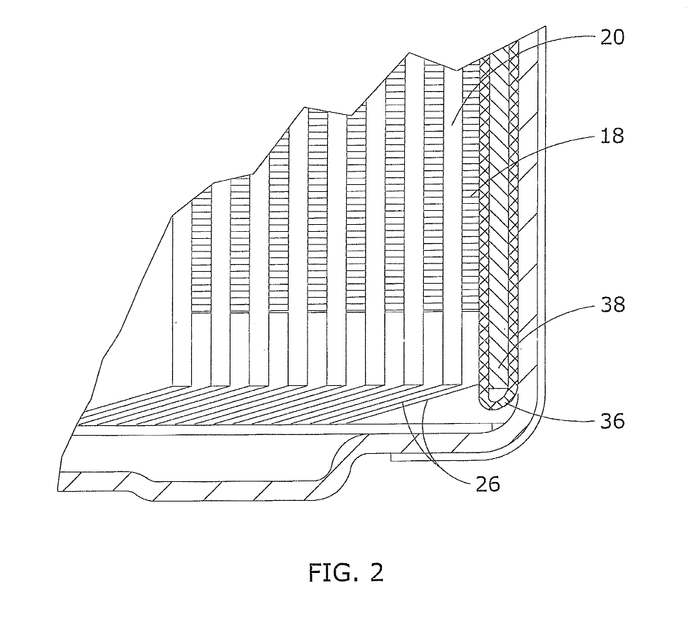

The invention will be better understood with reference to FIGS. 1 and 2. Cell 10 is a primary FR6 type cylindrical Li/FeS₂ cell. However, it is to be understood that, as described herein, the invention is applicable to other cell types, materials, and constructions. Cell 10 has a housing that includes a container in the form of a can 12 with a closed bottom and an open top end that is closed with a cell cover 14 and a gasket 16. The can 12 has a bead or reduced diameter step near the top end to support the gasket 16 and cover 14. The gasket 16 is compressed between the can 12 and the cover 14 to seal an anode or negative electrode 18, a cathode or positive electrode 20 and electrolyte within the cell 10. The anode 18, cathode 20 and a separator 26 are spirally wound together into an electrode assembly. The cathode 20 has a metal current collector 22, which extends from the top end of the electrode assembly and is connected to the inner surface of the cover 14 with a contact spring 24. The anode 18 is electrically connected to the inner surface of the can 12 by a current collector such as a tab or metal lead 36 (FIG. 2). The lead 36 is fastened to the anode 18, extends from the bottom of the electrode assembly and is folded across the bottom and up along the side of the electrode assembly in one embodiment. The lead 36 preferably makes pressure contact with the inner surface of the side wall of the can 12. After the electrode assembly is wound, it can be held together before insertion by tooling in the manufacturing process, or the outer end of material (e.g., separator or polymer film outer wrap 38) can be fastened down, by heat sealing, gluing or taping, for example.

As described herein, in one embodiment the anode lead includes an electrochemically active material and is dischargeable. To better utilize the dischargeable lead in one embodiment, the cathode is wound so that it overlaps interfacially with at least a portion of the lead but is electrically separated therefrom, preferably by the separator. When the cell has a jellyroll configuration, such as shown in FIG. 1, a portion of the cathode can be interfacially arranged with the axially extending portion of the lead in contact with the cell container by winding the electrode assembly so that at least a portion of the cathode is on the outer wind of the assembly and adjacent the lead, although electrically separated from the container and the lead. In this or a like manner, a majority of the lead can be positioned interfacial to a portion of the cathode to provide for the desired discharge of the lead.

An insulating cone 46 is located around the peripheral portion of the top of the electrode assembly to prevent the cathode current collector 22 from making contact with the can 12, and contact between the bottom edge of the cathode 20 and the bottom of the can 12 is prevented by the inward-folded extension of the separator 26 and an electrically insulating bottom disc 44 positioned in the bottom of can 12.

Cell 10 has a separate positive terminal cover 40, which is held in place by the inwardly crimped top edge of the can 12 and the gasket 16 and has one or more vent apertures (not shown). The can 12 serves as the negative contact terminal. An insulating jacket, such as an adhesive label 48, can be applied to the side wall of the can 12.

Disposed between the peripheral flange of the terminal cover 40 and the cell cover 14 is a positive temperature coefficient (PTC) device 42 that substantially limits the flow of current under abusive electrical conditions. Cell 10 also includes a pressure relief vent. The cell cover 14 has an aperture comprising an inward projecting central vent well 28 with a vent hole 30 in the bottom of the well 28. The aperture is sealed by a vent ball 32 and a thin-walled thermoplastic bushing 34, which is compressed between the vertical wall of the vent well 28 and the periphery of the vent ball 32. When the cell internal pressure exceeds a predetermined level, the vent ball 32, or both the ball 32 and bushing 34, is forced out of the aperture to release pressurized gases from the cell 10. In other embodiments, the pressure relief vent can be an aperture closed by a rupture membrane, such as disclosed in U.S. Patent Application Publication No. 2005/024470, herein fully incorporated by reference, or a relatively thin area such as a coined groove, that can tear or otherwise break, to form a vent aperture in a portion of the cell, such as a sealing plate or container wall.

In some embodiments, a current collector is utilized as a substrate or backing for the negative electrode. The current collector extends a distance, either all or a portion, either lengthwise or widthwise, or both, along the negative electrode, which is generally formed of a sheet-like, substantially planar construction, prior to further processing, such as rolling or winding with other electrode assembly components in the case of a cell having a jelly-roll configuration. The current collector can be in the form of a sheet or foil. When a current collector substrate or backing is utilized, the negative electrode material can be coated on the current collector or laminated or otherwise contacted with the current collector when the negative electrode material is in the form of a sheet.

When a current collector substrate or backing is used with a negative electrode, the current collector lead or tab can be directly connected to one or both of the current collector substrate and the negative electrode. The lead is directly connected to the negative electrode in one embodiment when the current collector substrate is not present. A further description regarding suitable leads or tabs is set forth in U.S. patent application Ser. No. 11/903,491 herein fully incorporated by reference.

As described herein, the electrochemical cells of the present invention include a battery life indicator or fuel gauge. The fuel gauge provides a voltage step or signal adapted to be detected by a device, in particular the device which is powered at least by a cell of the present invention. The voltage step generally indicates that the cell is near the end of its life and should be replaced in the case of a primary cell. The voltage step is provided at or above a functional voltage. By functional voltage, it is meant the cell voltage above which the device powered by the cell will function properly. As the functional voltage can vary according to the device in which the cell is utilized, in various embodiments, functional voltage is greater than or equal to 0.9 volt, 1.0 volt, 1.05 volts or 1.2 volts when the nominal voltage of the cell is about 1.5 volts, for example a Li/FeS₂ cell. Other cell systems such as Li/SO₂ and Li/MnO₂ can have a nominal voltage of about 3 volts and the functional voltage of about 2 volts. Typically, the functional voltage is at least about two-thirds of the nominal voltage. The voltage step is generally longer in duration and higher in voltage at relatively lower rates of discharge. Conversely, the voltage step is generally less pronounced at higher rates of discharge for the same cell. It is to be understood that a desired voltage step can be achieved at high rates by modifying cell design, such as by changing the area of the lead while maintaining a constant mass.

In addition to providing a cell with a fuel gauge, a further object of the invention is to provide a cell with increased capacity. The increased capacity is gained by providing the cell with an additional dischargeable component, dischargeable above the functional voltage. That is, it is not necessary to modify the negative electrode, such as lithium or a lithium alloy negative electrode or the positive electrode to increase the capacity.

In preferred embodiments, the beneficial features of the fuel gauge and additional capacity are realized by providing the cell with a dischargeable current collector, preferably for the negative electrode assembly. Either all or only a part of the current collector electrochemically active material can be consumed subject to the condition that some additional capacity is provided or fuel gauge signal is provided, and preferably a combination thereof. For example, the additional capacity provided by a dischargeable current collector can be in one embodiment, generally at least 5 mAh, desirably at least 10 mAh, and preferably at least 15 mAh.

The dischargeable current collector includes a material electrochemically active within the cell system. That is, active and dischargeable in the cell including a particular negative electrode, positive electrode and electrolyte. Preferred electro-chemically active materials for use in a current collector associated with a negative electrode include calcium, magnesium and sodium. One or combinations of the above can be utilized in a current collector. The calcium, magnesium and sodium can be alloyed with one or more other metals including, but not limited to, lithium as long as the desired capacity and fuel gauge indicator are provided. In order to keep the current collector dischargeable, the electrochemically active materials in the current collector have to have a continuous phase. In order to provide continuity, the current collector has a volume percent of the electrochemically active material of generally 50% or more, desirably 70% or more and preferably 80% or more based on the total volume of the current collector.

A further requirement of the electrochemically active material of the current collector is having a lower potential than the active material of the associated electrode, such as lithium of the negative electrode. The lower potential of the current collector serves a fuel gauge indicator by allowing the cell to first discharge at a higher voltage, which is determined by the potential of the electrode electrochemically active material, such as lithium in the case of a negative electrode. After the electrode is sufficiently discharged near the end of the life of the cell, the secondary electrochemically active material of the associated consumable current collector begins to discharge, provided the electrochemically active material of the non-associated electrode and/or current collector remains dischargeable. The percentage of discharge of the electrode prior to discharge of the current collector depends on factors such as the discharge rate of the cell and the application in which the cell is utilized. The discharge of the electrochemically active current collector is then observable as a second or further discharge voltage step or signal that can be recognized by a device as indicating that the cell is near the end of its life. For example, calcium has a standard potential of 2.84 volts, magnesium has a standard potential of 2.38 volts and sodium has a standard potential of 2.71 volts, which is less than the standard potential of lithium which is 3.01 volts.

In a preferred embodiment of the present invention, the electrode assembly, including the consumable current collector, has a total underbalance of active material when compared to the other electrode assembly. The underbalance of active material refers to the theoretical input capacity. The theoretical input capacity of an electrode assembly is the total contribution of the electrochemically active material of the electrode and any associated consumable current collector active material. Preferably, in one embodiment, the input capacity ratio of the anode, including a dischargeable anode current collector to cathode ratio is less than 1.0. Therefore, the anode and anode current collector are both essentially consumed upon discharge.

As indicated hereinabove, the lead or tab for the negative electrode of the cell can be utilized to provide additional capacity to the cell by being formed including an electrochemically active material. Table 1 set forth below provides non-limiting example embodiments of a current collector lead formed from each of calcium, magnesium and sodium. For the non-limiting embodiments illustrated, the lead capacity would add to the capacity of the cell an additional 29 mAh for calcium, 54 mAh for magnesium and 16 mAh for sodium. The leads set forth in Table 1 are suitable for an FR6 type cell.

TABLE 1

| | | | | | Lead | Lead | Lead |
|---|---|---|---|---|---|---|---|
| Lead | Potential | Capacity | Density | Lead Dimension | Volume | Weight | Capacity |
| Material | (V) | (mAh/g) | (g/cc) | (mm) | (cc) | (g) | (mAh) |
| Mg | −2.38 | 2200 | 1.74 | 53 × 4.75 × 0.05588 | 0.0141 | 0.0245 | 54 |
| Na | −2.71 | 1160 | 0.97 | 53 × 4.75 × 0.05588 | 0.0141 | 0.0136 | 16 |
| Ca | −2.84 | 1340 | 1.54 | 53 × 4.75 × 0.05588 | 0.0141 | 0.0217 | 29 |

The cell container is often a metal can with a closed bottom such as the can in FIG. 1. The can material will depend in part of the active materials and electrolyte used in the cell. A common material type is steel. For example, the can may be made of steel, plated with nickel on at least the outside to protect the outside of the can from corrosion. The type of plating can be varied to provide varying degrees of corrosion resistance or to provide the desired appearance. The type of steel will depend in part on the manner in which the container is formed. For drawn cans the steel can be a diffusion annealed, low carbon, aluminum killed, SAE 1006 or equivalent steel, with a grain size of ASTM 9 to 11 and equiaxed to slightly elongated grain shape. Other steels, such as stainless steels, can be used to meet special needs. For example, when the can is in electrical contact with the cathode, a stainless steel may be used for improved resistance to corrosion by the cathode and electrolyte.

The cell cover can be metal. Nickel plated steel may be used, but a stainless steel is often desirable, especially when the cover is in electrical contact with the cathode. The complexity of the cover shape will also be a factor in material selection. The cell cover may have a simple shape, such as a thick, flat disk, or it may have a more complex shape, such as the cover shown in FIG. 1. When the cover has a complex shape like that in FIG. 1, a type 304 soft annealed stainless steel with ASTM 8-9 grain size may be used, to provide the desired corrosion resistance and ease of metal forming. Formed covers may also be plated, with nickel for example.

The terminal cover should have good resistance to corrosion by water in the ambient environment, good electrical conductivity and, when visible on consumer batteries, an attractive appearance. Terminal covers are often made from nickel plated cold rolled steel or steel that is nickel plated after the covers are formed. Where terminals are located over pressure relief vents, the terminal covers generally have one or more holes to facilitate cell venting.

The gasket is made from any suitable thermoplastic material that provides the desired sealing properties. Material selection is based in part on the electrolyte composition. Examples of suitable materials include polypropylene, polyphenylene sulfide, tetrafluoride-perfluoroalkyl vinylether copolymer, polybutylene terephthalate and combinations thereof. Preferred gasket materials include polypropylene (e.g., PRO-FAX® 6524 from Basell Polyolefins, Wilmington, Del. USA), polybutylene terephthalate (e.g., CELANEX® PBT, grade 1600A from Ticona-U.S., Summit, N.J. USA) and polyphenylene sulfide (e.g., TECHTRON® PPS from Boedeker Plastics, Inc., Shiner, Tex. USA). Small amounts of other polymers, reinforcing inorganic fillers and/or organic compounds may also be added to the base resin of the gasket.

The gasket may be coated with a sealant to provide the best seal. Ethylene propylene diene terpolymer (EPDM) is a suitable sealant material, but other suitable materials can be used.

The vent bushing is made from a thermoplastic material that is resistant to cold flow at high temperatures (e.g., 75° C.). The thermoplastic material comprises a base resin such as ethylene-tetrafluoroethylene, polybutylene terephthlate, polyphenylene sulfide, polyphthalamide, ethylene-chlorotrifluoroethylene, chlorotrifluoroethylene, perfluoro-alkoxyalkane, fluorinated perfluoroethylene polypropylene and polyetherether ketone. Ethylene-tetrafluoroethylene copolymer (ETFE), polyphenylene sulfide (PPS), polybutylene terephthalate (PBT) and polyphthalamide are preferred. The resin can be modified by adding a thermal-stabilizing filler to provide a vent bushing with the desired sealing and venting characteristics at high temperatures. The bushing can be injection molded from the thermoplastic material. TEFZEL® HT2004 (ETFE resin with 25 weight percent chopped glass filler) is a preferred thermoplastic material.

The vent ball can be made from any suitable material that is stable in contact with the cell contents and provides the desired cell sealing and venting characteristic. Glasses or metals, such as stainless steel, can be used.

The anode comprises a strip of lithium metal, sometimes referred to as lithium foil. The composition of the lithium can vary, though for battery grade lithium the purity is always high. The lithium can be alloyed with other metals, such as aluminum, to provide the desired cell electrical performance. Battery grade lithium-aluminum foil containing 0.5 weight percent aluminum is available from Chemetall Foote Corp., Kings Mountain, N.C. USA.

The anode may have a non-consumable current collector in some embodiments, within or on the surface of the metallic lithium. As in the cell in FIG. 1, a separate current collector may not be needed, since lithium has a high electrical conductivity, but a current collector may be included, e.g., to maintain electrical continuity within the anode during discharge, as the lithium is consumed. When the anode includes a non-consumable current collector, it may be made of copper because of its conductivity, but other conductive metals can be used as long as they are stable inside the cell.

In a preferred embodiment, the anode or negative electrode is free of a separate current collector and the one or more strips or foil of lithium metal or lithium-containing alloy solely serve as a current collector due to the relatively high conductivity of the lithium or lithium-containing alloy. By not utilizing a current collector, more space is available within the container for other components, such as active materials. Providing a cell without an anode current collector can also reduce cell cost. Preferably a single layer or strip of lithium or a lithium-containing alloy is utilized as the negative electrode.

The electrical lead connects the anode or negative electrode to one of the cell terminals (the can in the case of the FR6 cell shown in FIG. 1). This may be accomplished embedding an end of the lead with a portion of the anode or by simply pressing a portion such as an end of the lead onto the surface of the lithium foil. The lithium or lithium alloy has adhesive properties and generally at least a slight, sufficient pressure or contact between the lead and electrode will weld the components together. In one preferred embodiment, the negative electrode is provided with a lead prior to winding into a jelly-roll configuration. For example, during production, a band comprising at least one negative electrode consisting of a lithium or lithium alloy is provided at a lead connecting station whereat a lead is welded onto the surface of the electrode at a desired location. The tabbed electrode is subsequently processed so that the lead is coined, if desired, in order to shape the free end of the lead not connected to the electrode. Subsequently, the negative electrode is combined with the remaining desired components of the electrode assembly, such as the positive electrode and separator, and wound into a jelly-roll configuration. Preferably after the winding operation has been performed, the free negative electrode lead end is further processed, by bending into a desired configuration prior to insertion into the cell container.

The electrically conductive negative electrode lead has a sufficiently low resistance in order to allow sufficient transfer of electrical current through the lead and have minimal or no impact on service lift of the cell. The desired resistance can be achieved by increasing the width and the thickness of the tab.

The cathode is in the form of a strip that comprises a current collector and a mixture that includes one or more electrochemically active materials, usually in particulate form. Iron disulfide (FeS₂) is a preferred active material. In a Li/FeS₂, cell the active material comprises greater than 50 weight percent FeS₂. The cathode can also contain one or more additional active materials, depending on the desired cell electrical and discharge characteristics. The additional active cathode material may be any suitable active cathode material. Examples include Bi₂O₃, C₂F, CFₓ, (CF)ₙ, CoS₂, CuO, CuS, FeS, FeCuS₂, MnO₂, Pb₂Bi₂O₅ and S. More preferably, the active material for a Li/FeS₂ cell cathode comprises at least 95 weight percent FeS₂, yet more preferably at least 99 weight percent FeS₂, and most preferably FeS₂ is the sole active cathode material. FeS₂ having a purity level of at least 95 weight percent is available from Washington Mills, North Grafton, Mass. USA; Chemetall GmbH, Vienna, Austria; and Kyanite Mining Corp., Dillwyn, Va. USA.

In addition to the active material, the cathode mixture contains other materials. A binder is generally used to hold the particulate materials together and adhere the mixture to the current collector. One or more conductive materials such as metal, graphite and carbon black powders may be added to provide improved electrical conductivity to the mixture. The amount of conductive material used can be dependent upon factors such as the electrical conductivity of the active material and binder, the thickness of the mixture on the current collector and the current collector design. Small amounts of various additives may also be used to enhance cathode manufacturing and cell performance. The following are examples of active material mixture materials for Li/FeS₂ cell cathodes. Graphite: KS-6 and TIMREX® MX15 grades synthetic graphite from Timcal America, Westlake, Ohio, USA. Carbon black: Grade C55 acetylene black from Chevron Phillips Company LP, Houston, Tex. USA. Binder: ethylene/propylene copolymer (PEPP) made by Polymont Plastics Corp. (formerly Polysar, Inc.) and available from Harwick Standard Distribution Corp., Akron, Ohio, USA; non-ionic water soluble polyethylene oxide (PEO): POLYOX® from Dow Chemical Company, Midland, Mich. USA; and G1651 grade styrene-ethylene/butylenes-styrene (SEBS) block copolymer from Kraton Polymers, Houston, Tex. Additives: FLUO HT® micronized polytetrafluoroethylene (PTFE) manufactured by Micro Powders Inc., Tarrytown, N.Y. USA (commercially available from Dar-Tech Inc., Cleveland, Ohio, USA) and AEROSIL® 200 grade fumed silica from Degussa Corporation Pigment Group, Ridgefield, N.J.

The current collector may be disposed within or imbedded into the cathode surface, or the cathode mixture may be coated onto one or both sides of a thin metal strip. Aluminum is a commonly used material. The current collector may extend beyond the portion of the cathode containing the cathode mixture. This extending portion of the current collector can provide a convenient area for making contact with the electrical lead connected to the positive terminal. It is desirable to keep the volume of the extending portion of the current collector to a minimum to make as much of the internal volume of the cell available for active materials and electrolyte.

A preferred method of making FeS₂ cathodes is to roll coat a slurry of active material mixture materials in a highly volatile organic solvent (e.g., trichloroethylene) onto both sides of a sheet of aluminum foil, dry the coating to remove the solvent, calender the coated foil to compact the coating, slit the coated foil to the desired width and cut strips of the slit cathode material to the desired length. It is desirable to use cathode materials with small particle sizes to minimize the risk of puncturing the separator. For example, FeS₂ is preferably sieved through a 230 mesh (62 μm) screen before use.

The cathode is electrically connected to the positive terminal of the cell. This may be accomplished with an electrical lead, often in the form of a thin metal strip or a spring, as shown in FIG. 1. The lead, when non-consumable, is often made from nickel plated stainless steel.

The separator is a thin microporous membrane that is ion-permeable and electrically nonconductive. It is capable of holding at least some electrolyte within the pores of the separator. The separator is disposed between adjacent surfaces of the anode and cathode to electrically insulate the electrodes from each other. Portions of the separator may also insulate other components in electrical contact with the cell terminals to prevent internal short circuits. Edges of the separator often extend beyond the edges of at least one electrode to insure that the anode and cathode do not make electrical contact even if they are not perfectly aligned with each other. However, it is desirable to minimize the amount of separator extending beyond the electrodes.

To provide good high power discharge performance it is desirable that the separator have the characteristics (pores with a smallest dimension of at least 0.005 μm and a largest dimension of no more than 5 μm across, a porosity in the range of 30 to 70 percent, an area specific resistance of from 2 to 15 ohm-cm² and a tortuosity less than 2.5) disclosed in U.S. Pat. No. 5,290,414, issued Mar. 1, 1994, and hereby incorporated by reference.

Suitable separator materials should also be strong enough to withstand cell manufacturing processes as well as pressure that may be exerted on the separator during cell discharge without tears, splits, holes or other gaps developing that could result in an internal short circuit. To minimize the total separator volume in the cell, the separator should be as thin as possible, preferably less than 25 μm thick, and more preferably no more than 22 μm thick, such as 20 μm or 16 μm. A high tensile stress is desirable, preferably at least 800, more preferably at least 1000 kilograms of force per square centimeter (kgf/cm²). For an FR6 type cell the preferred tensile stress is at least 1500 kgf/cm² in the machine direction and at least 1200 kgf/cm² in the transverse direction, and for a FR03 type cell the preferred tensile strengths in the machine and transverse directions are 1300 and 1000 kgf/cm², respectively. Preferably the average dielectric breakdown voltage will be at least 2000 volts, more preferably at least 2200 volts and most preferably at least 2400 volts. The preferred maximum effective pore size is from 0.08 μm to 0.40 μm, more preferably no greater than 0.20 μm. Preferably the BET specific surface area will be no greater than 40 m²/g, more preferably at least 15 m²/g and most preferably at least 25 m²/g. Preferably the area specific resistance is no greater than 4.3 ohm-cm², more preferably no greater than 4.0 ohm-cm², and most preferably no greater than 3.5 ohm-cm². These properties are described in greater detail in U.S. patent application Ser. No. 10/719,425, filed on Nov. 21, 2003, which is hereby incorporated by reference.

Separator membranes for use in lithium batteries are often polymeric separators made of polypropylene, polyethylene or ultrahigh molecular weight polyethylene, with polyethylene being preferred. The separator can be a single layer of biaxially oriented microporous membrane, or two or more layers can be laminated together to provide the desired tensile strengths in orthogonal directions. A single layer is preferred to minimize the cost. Suitable single layer biaxially oriented polyethylene microporous separator is available from Tonen Chemical Corp., available from EXXON Mobile Chemical Co., Macedonia, N.Y. USA. Setela F20DHI grade separator has a 20 μm nominal thickness, and Setela 16MMS grade has a 16 μm nominal thickness.

The anode, cathode and separator strips are combined together in an electrode assembly. The electrode assembly may be a spirally wound design, such as that shown in FIG. 1, made by winding alternating strips of cathode, separator, anode and separator around a mandrel, which is extracted from the electrode assembly when winding is complete. At least one layer of separator and/or at least one layer of electrically insulating film (e.g., polypropylene) is generally wrapped around the outside of the electrode assembly. This serves a number of purposes: it helps hold the assembly together and may be used to adjust the width or diameter of the assembly to the desired dimension. The outermost end of the separator or other outer film layer may be held down with a piece of adhesive tape or by heat sealing. The anode can be the outermost electrode, as shown in FIG. 1, or the cathode can be the outermost electrode. Either electrode can be in electrical contact with the cell container, but internal short circuits between the outmost electrode and the side wall of the container can be avoided when the outermost electrode is the same electrode that is intended to be in electrical contact with the can.

In one or more embodiments of the present invention, the electrode assembly is formed with the positive electrode having electrochemically active material selectively deposited thereon for improved service and more efficient utilization of the electrochemically active material of the negative electrode. Non-limiting examples of selectively deposited configurations of electrochemically active material on the positive electrode and further, an electrochemical cell, including a positive container, are set forth in U.S. Publication No. 2008/0026288, published on Jan. 31, 2008 and U.S. Publication No. 2008/0026293, published on Jan. 31, 2008, both fully herein incorporated by reference.

In one embodiment, a primary electrochemical cell comprises a non-intercalating negative lithium electrode and an iron disulfide positive electrode, wound into a jellyroll configuration with a separator disposed between the two electrodes. The jellyroll is disposed in a cylindrical housing along with a non-aqueous organic electrolyte. Notably, the iron disulfide is coated onto a substrate, but in a manner that leaves a partially uncoated portion on one side of the carrier that extends from one axial edge of the substrate toward its opposing axial edge. The uncoated portion follows a longitudinal axis along the height of the jellyroll/cell container, when the jellyroll is created. A second partially uncoated portion may be provided, preferably on the opposite side of the substrate, so as to form a second longitudinal axis. These longitudinal axes may overlap (i.e., be directly proximate to one another but on opposite sides of the substrate) or be offset from one another. The uncoated portion can then be aligned on the outer circumference and/or the innermost core of the jellyroll, eliminating the need to place lithium adjacent to the uncoated portion(s), reducing the amount of lithium required and generally allowing for a cost savings in the construction of the cell. In a preferred embodiment, when a dischargeable negative electrode lead is used, at least a portion of the cathode is interfaced with the lead, preferably on the outer circumference of the jellyroll.

In a further embodiment, an electrode assembly comprises a negative electrode of lithium and a positive electrode with electrochemically active material coated on a foil carrier. Here again, the electrodes are spirally wound with a separator into a jellyroll and disposed in a cylindrical container along with a non-aqueous electrolyte. In this case, the conductive carrier has a lengthwise section running from one end of the foil to another without coating on either side that is preferably oriented at the top end of the jellyroll. As above, at least one uncoated portion extends across the width of the foil carrier. If multiple uncoated portions are provided, the first and second uncoated portions may partially or completely overlap (i.e., be proximate to one another but on opposing sides of the foil carrier). However, if a third uncoated portion is provided by a coated portion (i.e., except for the uncoated lengthwise section), the first and third sections must have a coated portion interposed therebetween.

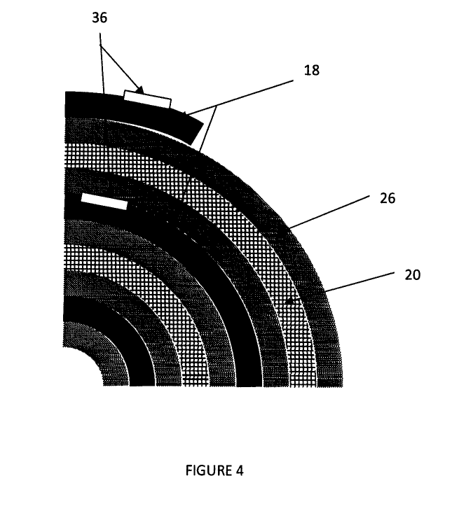

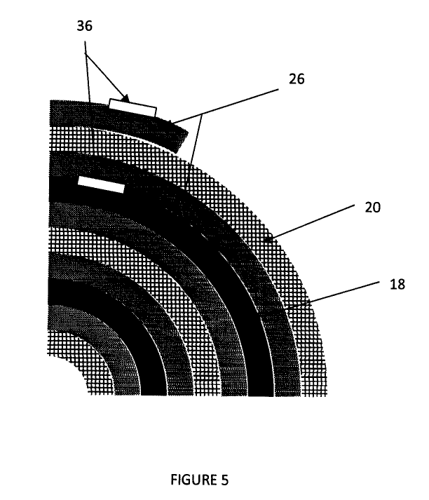

Various coating patterns and additional teachings regarding patterned positive electrodes are set forth in the incorporated references. FIGS. 4 and 5 show various jellyroll electrode assembly arrangements including a negative electrode 18, a positive electrode 20 and a portion of a negative electrode lead 36, wherein the materials of different polarity are separated by an appropriate separator 26.

Rather than being spirally wound, the electrode assembly may be formed by folding the electrode and separator strips together. The strips may be aligned along their lengths and then folded in an accordion fashion, or the anode and one electrode strip may be laid perpendicular to the cathode and another electrode strip and the electrodes alternately folded one across the other (orthogonally oriented), in both cases forming a stack of alternating anode and cathode layers.

The electrode assembly is inserted into the housing container. In the case of a spirally wound electrode assembly, whether in a cylindrical or prismatic container, the major surfaces of the electrodes are perpendicular to the side wall(s) of the container (in other words, the central core of the electrode assembly is parallel to a longitudinal axis of the cell). Folded electrode assemblies are typically used in prismatic cells. In the case of an accordion-folded electrode assembly, the assembly is oriented so that the flat electrode surfaces at opposite ends of the stack of electrode layers are adjacent to opposite sides of the container. In these configurations the majority of the total area of the major surfaces of the anode is adjacent the majority of the total area of the major surfaces of the cathode through the separator, and the outermost portions of the electrode major surfaces are adjacent to the side wall of the container. In this way, expansion of the electrode assembly due to an increase in the combined thicknesses of the anode and cathode is constrained by the container side wall(s).

A nonaqueous electrolyte, containing water only in very small quantities as a contaminant (e.g., no more than about 500 parts per million by weight, depending on the electrolyte salt being used), is used in the battery cell of the invention. Any nonaqueous electrolyte suitable for use with lithium and active cathode material may be used. The electrolyte contains one or more electrolyte salts dissolved in an organic solvent. For a Li/FeS₂ cell examples of suitable salts include lithium bromide, lithium perchlorate, lithium hexafluorophosphate, potassium hexafluorophosphate, lithium hexafluoroarsenate, lithium trifluoromethanesulfonate and lithium iodide; and suitable organic solvents include one or more of the following: dimethyl carbonate, diethyl carbonate, methylethyl carbonate, ethylene carbonate, propylene carbonate, 1,2-butylene carbonate, 2,3-butylene carbonate, methyl formate, γ-butyrolactone, sulfolane, acetonitrile, 3,5-dimethylisoxazole, n,n-dimethyl formamide and ethers. The salt/solvent combination will provide sufficient electrolytic and electrical conductivity to meet the cell discharge requirements over the desired temperature range. Ethers are often desirable because of their generally low viscosity, good wetting capability, good low temperature discharge performance and good high rate discharge performance. This is particularly true in Li/FeS₂ cells because the ethers are more stable than with MnO₂ cathodes, so higher ether levels can be used. Suitable ethers include, but are not limited to acyclic ethers such as 1,2-dimethoxyethane, 1,2-diethoxyethane, di(methoxyethyl)ether, triglyme, tetraglyme and diethyl ether; and cyclic ethers such as 1,3-dioxolane, tetrahydrofuran, 2-methyl tetrahydrofuran and 3-methyl-2-oxazolidinone.

Specific anode, cathode and electrolyte compositions and amounts can be adjusted to provide the desired cell manufacturing, performance and storage characteristics, as disclosed in U.S. patent application Ser. No. 10/719,425, which is referenced above.

The cell can be closed and sealed using any suitable process. Such processes may include, but are not limited to, crimping, redrawing, colleting and combinations thereof. For example, for the cell in FIG. 1, a bead is formed in the can after the electrodes and insulator cone are inserted, and the gasket and cover assembly (including the cell cover, contact spring and vent bushing) are placed in the open end of the can. The cell is supported at the bead while the gasket and cover assembly are pushed downward against the bead. The diameter of the top of the can above the bead is reduced with a segmented collet to hold the gasket and cover assembly in place in the cell. After electrolyte is dispensed into the cell through the apertures in the vent bushing and cover, a vent ball is inserted into the bushing to seal the aperture in the cell cover. A PTC device and a terminal cover are placed onto the cell over the cell cover, and the top edge of the can is bent inward with a crimping die to hold retain the gasket, cover assembly, PTC device and terminal cover and complete the sealing of the open end of the can by the gasket.

The above description is particularly relevant to cylindrical Li/FeS₂ cells, such as FR6 and FR03 types, as defined in International Standards IEC 60086-1 and IEC 60086-2, published by the International Electrotechnical Commission, Geneva, Switzerland. However, the invention may also be adapted to other cell sizes and shapes and to cells with other electrode assembly, housing, seal and pressure relief vent designs. Other cell types in which the invention can be used include primary and rechargeable nonaqueous cells, such as lithium/manganese dioxide and lithium ion cells. The electrode assembly configuration can also vary. For example, it can have spirally wound electrodes, as described above, folded electrodes, or stacks of strips (e.g., flat plates). The cell shape can also vary, to include cylindrical and prismatic shapes, for example. Other cell chemistries such as, but not limited to, Li/SO₂, Li/AgCl, Li/V₂O₅, Li/MnO₂, Li/Bi₂O₃ can be utilized. These batteries could have a nominal voltage higher than 1.50 V such as 2.0 V and 3.0 V.

### EXAMPLE

In order to illustrate a dischargeable collector of the present invention, a cell having a non-dischargeable lead was compared to a cell containing a dischargeable magnesium lead connected between the negative electrode and a sidewall of the cell container. The cell constructions were similar to the cell shown in FIGS. 1 and 2. Both cells were lithium/FeS₂ type cells having an anode to cathode theoretical input capacity ratio of less than 1.0. The non-dischargeable lead-containing cell utilized a cold-rolled steel lead positioned between the negative electrode and the sidewall of the container. The cold-rolled steel lead had a length of 53 mm, width of 4.75 mm, and a thickness of 0.05588 mm. The magnesium lead had the same length and width as the cold-rolled steel lead, but the thickness was 0.254 mm. The cell of the invention utilized a magnesium lead prepared from magnesium obtained from Magnesium Elektron North America, Inc., Madison, Ill. The magnesium lead contained about 5.8 to 7.2 wt. % aluminum. A portion of the magnesium lead was interfaced with the cathode by extending the cathode to the end of the anode around the outer circumference of the electrode assembly. The total lithium input capacity in the cell with the dischargeable lead was less than the input capacity of lithium with the non-dischargeable lead, but the interfacial lithium in both cells was very similar.

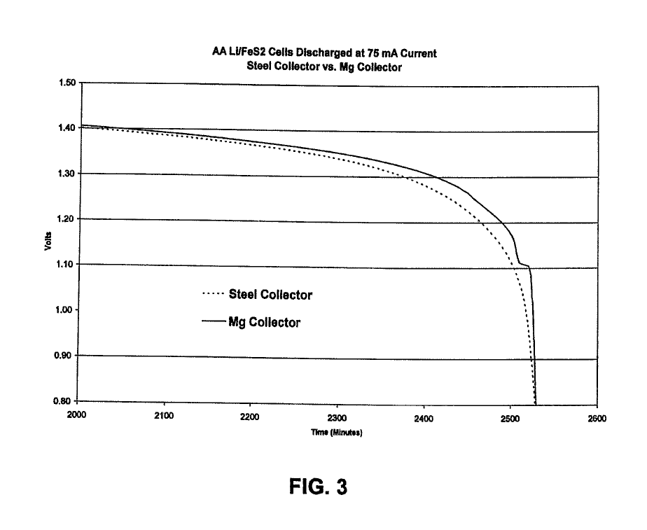

Both cells were discharged at 75 mA continuously and the discharge of the cells was plotted in FIG. 3. As illustrated in FIG. 3, it can be seen that the cell with the dischargeable lead exhibited a second discharge step, attributed to the magnesium of the lead at around 2500 minutes and about 1.1 volts. Accordingly, the second discharge step can be utilized as a warning sign for end of life of the cell. The dischargeable lead also provided additional capacity to the cell.

It will be understood by those who practice the invention and those skilled in the art that various modifications and improvements may be made to the invention without departing from the spirit of the disclosed concepts. The scope of protection afforded is to be determined by the claims and by the breadth of interpretation allowed by law.

What is claimed is:

1. A primary electrochemical cell, comprising:
a conductive container of a first polarity sealed by an end assembly having a contact of a second polarity;
an electrode assembly including a positive electrode, a negative electrode, and a separator disposed between the positive electrode and negative electrode, wherein one of the electrodes is in operative electrical contact with the container and the other electrode is in operative electrical contact with the contact of the end assembly;
an electrolyte; and
a consumable current collector in electrical contact with the negative electrode, wherein the current collector includes a dischargeable electrochemically active material having a lower potential than an electrochemically active material of the negative electrode, and wherein the consumable current collector has a functional voltage within the cell.

2. An electrochemical cell, comprising:
a conductive container having a closed end, an open end sealed by an end assembly, and a sidewall extending between the closed end and the open end;
a positive electrode;
a negative electrode consisting essentially of lithium or a lithium alloy;
a separator;
a nonaqueous, organic electrolyte;
a current collector in electrical contact with the negative electrode, wherein the current collector includes a dischargeable electrochemically active material having a lower potential than the lithium and lithium alloy, wherein the current collector has a functional voltage in the cell; and
wherein the positive electrode, the negative electrode and the separator are wound into a jellyroll electrode assembly and the negative electrode is operatively in electrical contact with the container or the end assembly.

3. The electrochemical cell according to claim 2, wherein the current collector electrochemically active material is one or more of calcium, magnesium and sodium.

4. The electrochemical cell according to claim 3, wherein the current collector is an internal lead located in the container and in electrical contact with the negative electrode and with a portion of the container or the end assembly.

5. The electrochemical cell according to claim 2, wherein the functional voltage is greater than or equal to 0.90 volt, and wherein the current collector provides additional capacity to the cell above the functional voltage.

6. The electrochemical cell according to claim 4, wherein the electro-chemically active material accounts for 50 volume percent or more of the lead.

7. The electrochemical cell according to claim 2, wherein the current collector in electrical contact with the negative electrode has a capacity of at least 5 mAh.

8. The electrochemical cell according to claim 2, wherein the positive electrode comprises iron disulfide, wherein a theoretical anode-to-cathode input capacity ratio for the cell is less than 1.0, and wherein the anode input capacity includes the lithium or lithium alloy and the dischargeable electrochemically active material of the current collector.

9. The electrochemical cell according to claim 4, wherein the lead is connected to a lower portion of the negative electrode and is in pressure contact with the sidewall or a bottom wall of the container.

10. The electrochemical cell according to claim 5, wherein upon discharge the cell exhibits at least two steps on a discharge curve above the functional voltage of the cell.

11. The electrochemical cell according to claim 2, wherein a nominal voltage of the cell is about 1.5 volts, wherein the cell is a primary cell, and wherein the positive electrode comprises iron disulfide.

12. An electrochemical cell, comprising:
a substantially cylindrical, conductive container having a closed end, an open end sealed by an end assembly, and a sidewall extending between the closed end and the open end;
a positive electrode;
a negative electrode consisting essentially of lithium or a lithium alloy;
a separator;
a nonaqueous, organic electrolyte;
a current collector in electrical contact with the negative electrode, wherein the current collector includes at least 50% by volume of one or more of calcium, magnesium and sodium, and wherein the current collector is dischargeable; and
wherein the positive electrode, the negative electrode and the separator are wound into a jellyroll electrode assembly and the negative electrode is operatively in electrical contact with the container or the end assembly.

13. An electrochemical cell according to claim 12, wherein the current collector is dischargeable at a voltage of greater than or equal to 0.90 volt.

14. An electrochemical cell according to claim 13, wherein the current collector is an internal lead located in the container and in electrical contact with the negative electrode and with a portion of the container or the end assembly.

15. An electrochemical cell according to claim 14, wherein a nominal voltage of the cell is about 1.5 volts, wherein the cell is a primary cell, and wherein the positive electrode comprises iron disulfide.

16. An electrochemical cell according to claim 15, wherein the current collector includes at least 80% by volume of the one or more calcium, magnesium and sodium.

17. An electrochemical cell according to claim 16, wherein upon discharge, the cell exhibits at least two steps on a discharge curve at a voltage greater than or equal to 0.90 volt, wherein a theoretical anode-to-cathode input capacity ratio for the cell is less than 1.0, and wherein the anode input capacity includes the lithium or lithium alloy and the dischargeable electrochemically active material of the current collector.

18. An electrochemical cell, comprising:
a substantially cylindrical, conductive container having a closed end, an open end sealed by an end assembly, and a sidewall extending between the closed end and the open end;
a positive electrode;
a negative electrode consisting essentially of lithium or a lithium alloy;
a separator;
a nonaqueous, organic electrolyte;
a consumable internal lead located in the container and in electrical contact with the negative electrode and a portion of the container or the end assembly, wherein the lead includes a dischargeable electrochemically active material having a lower potential than the lithium and the lithium alloy, wherein the lead has a functional voltage in the cell; and
wherein the positive electrode, the negative electrode and the separator are wound into a jellyroll electrode assembly and the negative electrode is operatively in electrical contact with the container or the end assembly.

19. An electrochemical cell according to claim 19, wherein the lead electrochemically active material is one or more of calcium, magnesium and sodium, and wherein the electrochemically active material accounts for 50 volume percent or more of the lead.

20. An electrochemical cell according to claim 20, wherein the positive electrode comprises iron disulfide, wherein a theoretical anode-to-cathode input capacity ratio for the cell is less than 1.0, and wherein the anode input capacity includes the lithium or lithium alloy and the dischargeable electrochemically active material of the lead.

21. An electrochemical cell according to claim 21, wherein the functional voltage is greater than or equal to 0.90 volt, and wherein upon discharge the cell exhibits at least two steps on a discharge curve above the functional voltage of the cell.

22. An electrochemical cell according to claim 18, wherein a nominal voltage of the cell is between about 1.5 volts and about 3.0 volts, and wherein the cell is a primary cell.
